(19) United States
(12) Patent Application Publication
(10) Pub. No.: US 2014/0115622 A1
(43) Pub. Date: Apr. 24, 2014

(54) Interactive Video/Image-relevant Information Embedding Technology

(71) Applicants: Chi-Hsiang Chang, New Taipei City (TW); Wei-Yao Lin, Shanghai (CN)

(72) Inventors: Chi-Hsiang Chang, New Taipei City (TW); Wei-Yao Lin, Shanghai (CN)

(21) Appl. No.: 13/654,720

(22) Filed: Oct. 18, 2012

(51) Int. Cl. H04N 21/854

(52) U.S. Cl. 725/25; 725/37

(57) ABSTRACT

An interactive video/image-relevant information embedding technology contains: a server side including a user client-server operation interface module for interacting with the client side; a video/image database for saving videos/images; a label database for saving external information; a video/image content analysis module for segmenting, tracking, recognizing specified items in the videos/images; an external-information retrieval engine for retrieving external information from the public search engine, label database, or additional database; a video/image-external information relation analysis module for creating on-the-fly labels for the specified items in videos/images; a client side which includes: a client-server operation interface module for interacting with the server side; a user operation interface module for interacting with the user/label creator; an original video/image database for saving videos/images; a label information database for saving external information; a video/image content analysis module for segmenting, tracking, recognizing specified items in the videos/images; a label-embedding engine for creating label files for the videos/images.

### BRIEF SUMMARY OF THE INVENTION

In video/image applications, people are often interested in achieving the external information relevant to the video/image contents. In this invention, we propose to embed the relevant information into videos/images in an interactive way, such that this relevant information can show up or clickable when people move their cursor on the specific items in the video/image.

### Keywords: List Keywords or Combinations of Keywords to Guide Patent and Literature Searches. Underline the Most Important Keywords

External information embedding in videos/images, Interactive display of video/image-relevant information

### Brief Discussion of the Problem Solved by the Invention

In video/image applications, people are often interested in achieving the external information relevant to the video/image contents. For example, people may want to know the brand of the actor' s cloth during a drama or the detailed information of some items in a news video. However, currently, this external information cannot be easily accessible in the videos/images, making it inconvenient for people to achieve their desired relevant information. In this invention, we propose to embed the relevant information into videos/images in an interactive way, such that this relevant information can show up or clickable when people move their cursor on the specific items in the video/image. Such interactive approach can provide user with a convenient way for acquiring other video/image-content-relevant information.

### Discussion of How You or Others Have Implemented Similar Things in the Past, Including the Manner in Which Others Have Attempted to Solve the Problem. Point out Disadvantages and Weaknesses in Previous Practice. Include Literature References Where Available

Traditionally, external information related to the videos/images cannot be acquired directly. When people want to achieve external information about an item in the video/image, they need to look up this information separately using other tools such as search engines.

Currently, although some image applications have embedded some external information, they have the limitations that (a) most of the external information is embedded beforehand, which has great inflexibility, and (b) none of them are extended to videos.

As for videos, the existing embedding techniques such as subtitle embedding or comment embedding are either predefined or non-user-interactive (i.e., the external information cannot be adaptive with users' current attention).

In this invention, we propose to embed the relevant information into videos/images in an interactive way, such that the relevant information can show up or clickable when people move their cursor on the specific items in the video/image.

### Description of the Invention, Including One or More Practical Embodiments of the Invention in Sufficient Detail to Allow One With Ordinary Skill in the Art to Practice the Invention. Point Out Important Features and Items You Beleive to be New. State Advantages of the Invention and Sacrifices, if any, Made to Achieve These Advantages. Describe any Experiments Conducted and the Results of Those Experiments

This invention provides an interactive framework for embedding and acquiring external information about the items in the video/image contents. The invention can be used in applications such as advertisement embedding, interactive external information providing, and etc. In this invention, we name the embedded external information as the “label”.

The invented framework includes two parts: the client part (110) and the server part (120). The server part includes the user client-server operation interface module (121), the video/image database (122), the label database (123), video/image content analysis module (124), video/image-external information relation analysis module (125), and external-information retrieval engine (126).

The client part includes the client-server operation interface module (111), video/image content analysis module (112), label-embedding engine (113), original video/image database (114), label information database (115), and the user operation interface module (116). The user client-server operation interface module in the server side is used for interaction between the client and the server sides for uploading/downloading files, user information verification, user log-in operation, transferring operation information, and other operations. The video/image database in the server side saves the video/image data, and the label database saves the created label files which include the related external information to the video/image. Normally, each video/image will have its correspond label file in the label dataset. The video/image content analysis module on the server side will receive the operation information from the client side through the user client-server operation interface module. After it is triggered, it will operate on segmenting, tracking, and recognizing the specific item in the video/image defined by the operation information. The external-information retrieval engine receives the information from both the video/image content analysis module and the client side through the user client-server operation interface module. After it is triggered by the operation information from the client side, it will receive the item information from the video/image content analysis module and retrieve the related information from the public search engines, label database, or other additional database. The video/image-external information relation analysis module receives the information from three modules: the external-information retrieval engine, the video/image content analysis module, and the user client-server operation interface module. After it receives the operation information from the user client-server operation interface module, it will receive the item information from the video/image content analysis module and the retrieved external information from the external-information retrieval engine, after that, it will create the label which is related to the items defined from the client side. The created label information will be sent to the client side through the client-server operation interface module. At the same time, the label information will also be saved into a label file in the label database.

The user client-server operation interface module in the client side is also used for interaction between the client and the server sides for uploading/downloading files, user information verification, user log-in operation, transferring operation information, and other operations. The user operation interface module is used for interacting with the user or label creator for uploading videos/images, adding label information, creating information-embedded videos/images, playing information-embedded videos/images, acquiring interested items or item information, and other operations. The original video/image database in the client side saves the original video/image data. New videos/images can be added to this dataset from the video/image database on the server side or through the user operation interface module. The label information database saves the available external information that may be used for creating labels. New information can be added to this dataset from the label dataset on the server side or added by the users through the user operation interface module. The video/image content analysis module on the client side receives the operation information from the users or label creators through the operation interface module. After it is triggered, it will operate on segmenting, tracking, and recognizing the specific item in the video/image defined by the operation information. The label-embedding engine receives information from three sides: the video/image content analysis module, the label information database, and the user operation interface module. When label-embedding engine is triggered, it will first extract the label information either from the label information database or directly from the label creators through the user operation interface module. The engine will also receive the item information from the video/image content analysis module. After that, the label-embedding engine will create the label which is related to the specified items. The created label information will be saved into a file and can either be saved on the label information database on the client side or be uploaded to the label database on the server side.

The original video/image together with its corresponding label information file is called the information embedded video/image. Normally, each information embedded video/image includes one original video/image and one label information file. Rather, it is also possible for the information embedded video/image to include multiple label information files. The information embedded video/image can be played through the user operation interface module for interactive external information display. The label information file includes the location, region size, and the corresponding external information for the specific items in the videos/images. During video/image play, the video/image player in the user operation interface module will coherently parse the label file according to the user operation information (e.g., the cursor' s location of the user). When the user moves the cursor on some specified item whose region has been specified by the label file, the corresponding external information for this item will pop-up. Otherwise (i.e., the curser is not moved to the region specified by the label file), no external information will pop-up and the video/image will play as regular forms.

In the following, two embodiments (or two modes) of the invented framework will be described in detail: the creator-user mode (i.e., embodiment 1) and the user-centered mode (i.e., embodiment 2).

In embodiment 1 (the creator-user mode), at the client side, the label creator (e.g., the advertisement creator) first selects a suitable video/image either from the original video/image database or uploading one by himself. Then, the label creator can choose suitable items in the video/image that they want to embed information through the user operation interface module (the item examples includes the clothes, objects), the user operation interface module will trigger the video/image content analysis module for automatically segmenting and tracking the selected items in the video/image. At the same time, the label creator will either input the item-related label information directly or retrieve a suitable label through the label information database. The user operation interface module will trigger the label-embedding engine to embed the label information into the video/image and create an independent label file. After that, the video/image together with its corresponding label file will be uploaded to the server through the client-server operation interface module.

At the server side, the server receives the video/image and the label file through the user client-server operation interface module, and then save them into the video/image database and the label database, respectively.

The video/image viewers (i.e., the users) also view videos/images from another client side. The video/image viewers first select their interested videos/images through the user operation interface module. The user operation interface module directly retrieves the videos/images and their corresponding label files from the video/image database and the label database in the server through the user client-server operation interface module, and then plays the videos/images on the client side. When the users move their cursor on their interested items in the videos/images, the corresponding embedded labels in the label files will be triggered and will pop-up such that the external information related to the item will display in the pop-up labels.

In embodiment 2 (user-centered mode), at the client side, the video/image viewers (i.e., the users) first select their interested videos/images through the user operation interface module. The user operation interface module directly retrieves the videos/images from the video/image database on the server side, and then plays the videos/images on the client side. When users move their cursor or select their interested items in the videos/images, the video/image content analysis module on the server side will be triggered to automatically segment, track, and recognize the items in the videos/images. The output of the video/image content analysis module will be the location and the recognized information of the items. After that, the recognized item information will be input into the external-information retrieval engine for retrieving the external information from either the public search engine, or the additional database, or the label database. The output of the external-information retrieval engine will be the related external information of the user-selected items. Finally, these retrieved external information and the recognized item information will be input into the video/image-external information relation analysis module for analyzing their relationship and creating suitable labels for the user-selected items. The created labels will pop-up next to the user-selected item. At the same time, the label information will also be saved into the label file in the label database on the server side.

Note that compared with embodiment 1 which creates labels beforehand, the labels in embodiment 2 are created on-the-fly.

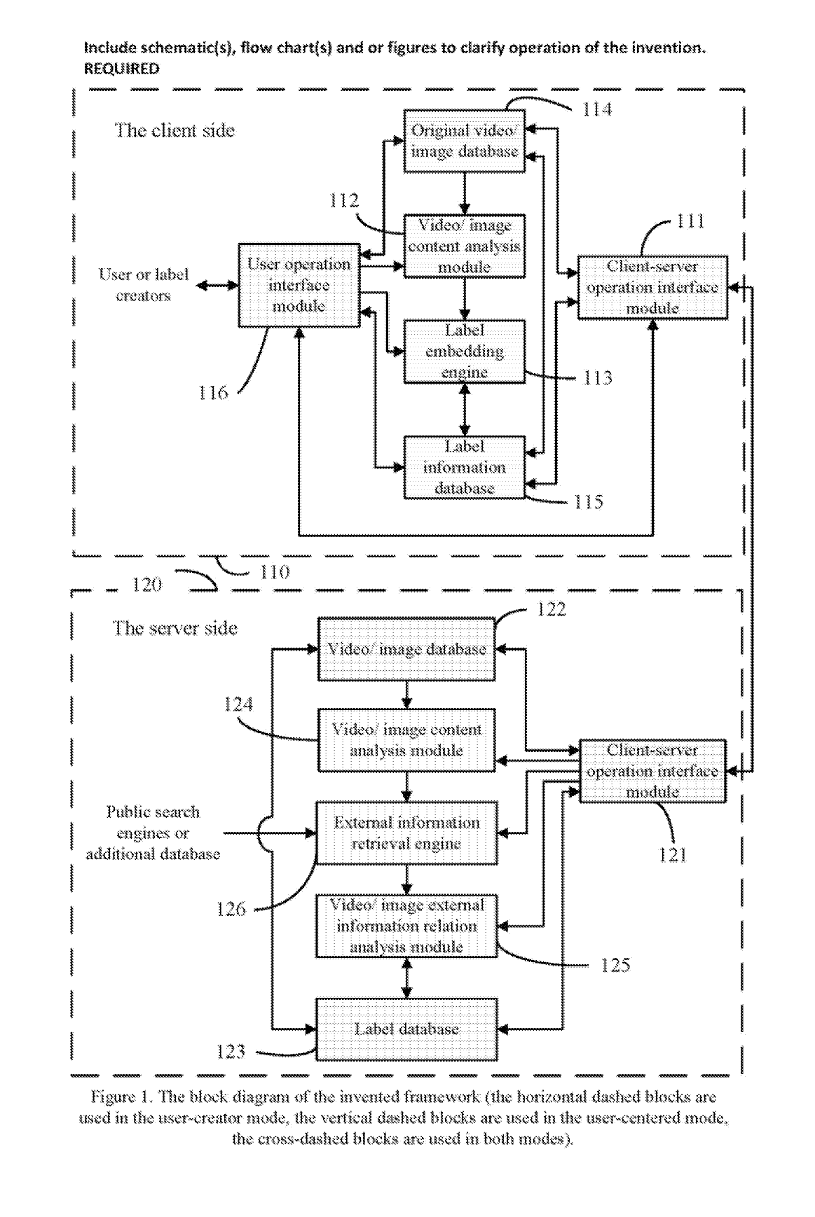

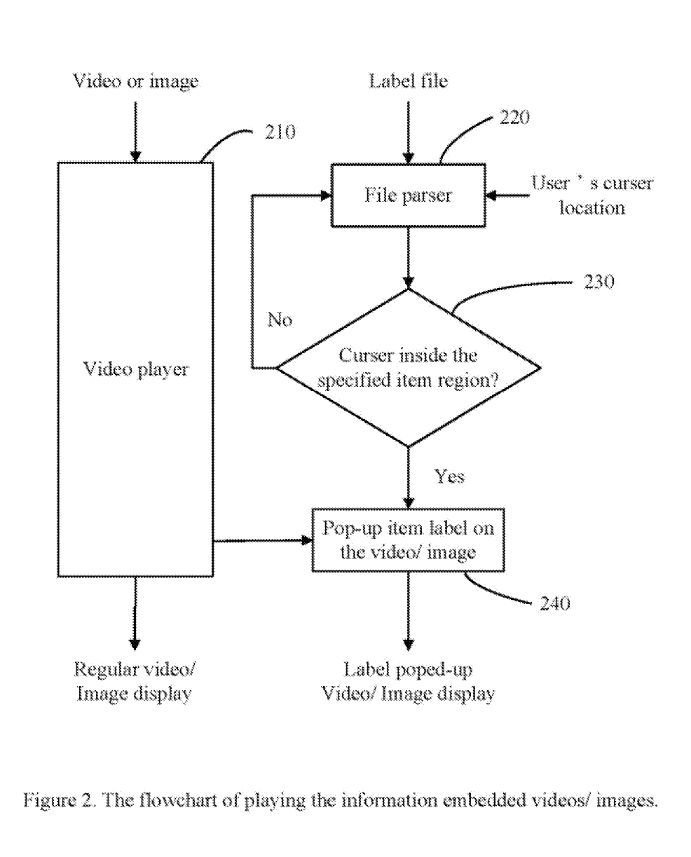

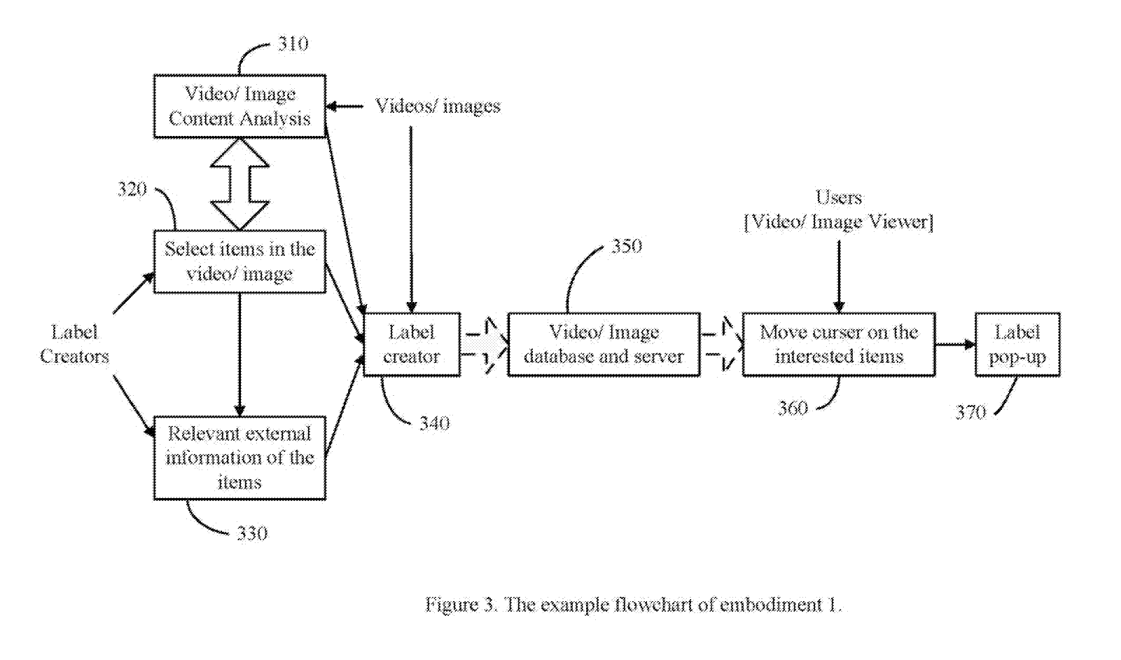

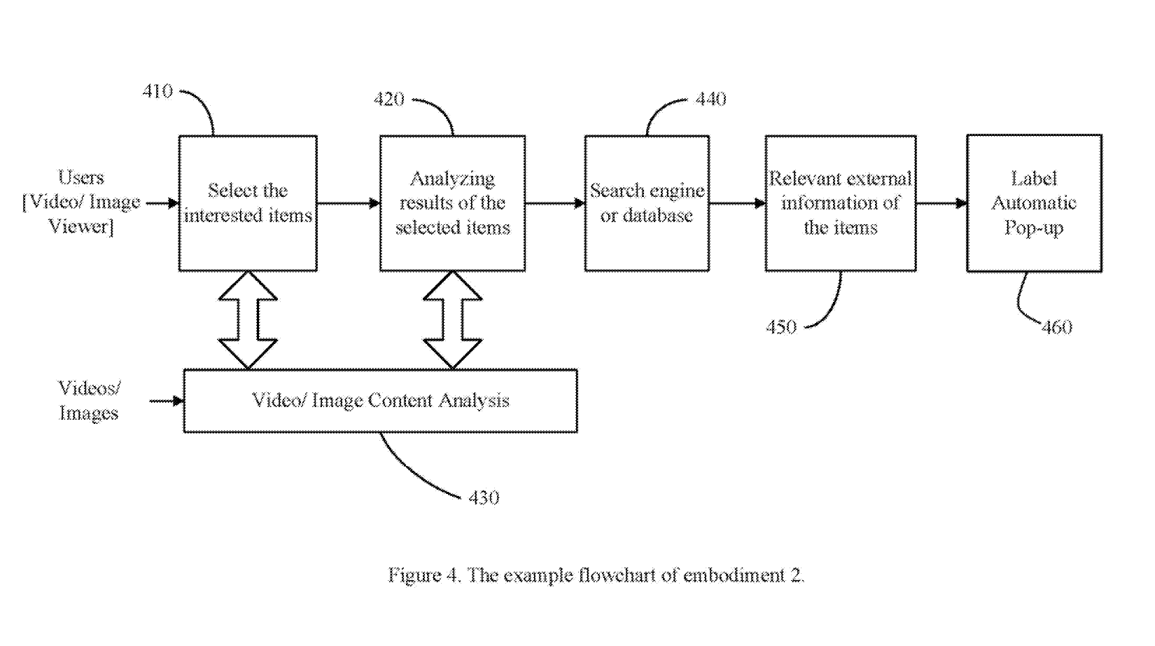

The block diagram of the invented framework is shown in FIG. 1. The flowchart of playing the information embedded videos/images is shown in FIG. 2. The flowchart of embodiment 1 and embodiment 2 is shown in FIGS. 3 and 4, respectively

1. An interactive video/image-relevant information embedding technology for embedding and acquiring external information about the items in the video/image contents, including:
A server side which includes:
a user client-server operation interface module for interacting with the client side;
a video/image database for saving videos/images;
a label database for saving corresponding external information;
a video/image content analysis module for segmenting, tracking, recognizing specified items in the videos/images;
an external-information retrieval engine for retrieving external information from the public search engine, label database, or additional database;
a video/image-external information relation analysis module for creating on-the-fly labels for the specified items in videos/images; and
A client side which includes:
a client-server operation interface module for interacting with the server side;
a user operation interface module for interacting with the user/label creator;
an original video/image database for saving videos/images;
a label information database for saving external information related to items;
a video/image content analysis module for segmenting, tracking, recognizing specified items in the videos/images;
a label-embedding engine for creating label files for the videos/images.

2. The interactive video/image-relevant information embedding technology of claim 1, wherein the framework can work on multiple modes, including:
a user-creator mode (i.e., embodiment 1) where the label creator creates the label from the client side beforehand, and upload the information-embedded videos/images onto the server side. The video/image viewer (i.e., users) select and play the videos/images from the server side for interactive external information display.
a user-centered mode (i.e., embodiment 2) where the video/image viewer (i.e., users) directly select the items in videos/images, and the external information and the labels are retrieved and created on-the-fly through item recognition and real-time information retrieval.

3. The interactive video/image-relevant information embedding technology of claim 1, wherein for the information-embedded videos/images:
an information-embedded video/image includes (a) the video/image file, (b) the accompany label file indicating the specified item location, item region area, and the corresponding external information;
during video/image play, the corresponding label file will be coherently parsed according to the user operation information. When the user moves the cursor on some specified item whose region has been specified by the label file, the corresponding external information for this item will pop-up. Otherwise, no external information will pop-up and the video/image will play as regular forms;
the information embedded videos/images can be played either from the client side through the user operation interface module, or directly on the server through the user operation interface module and the client-server operation interface module;
a lock/unlock bottom can be used to disable/enable the label pop-up functionality in videos/images.

4. The interactive video/image-relevant information embedding technology of claim 2, wherein for the information-embedded videos/images:
an information-embedded video/image includes (a) the video/image file, (b) the accompany label file indicating the specified item location, item region area, and the corresponding external information;
during video/image play, the corresponding label file will be coherently parsed according to the user operation information. When the user moves the cursor on some specified item whose region has been specified by the label file, the corresponding external information for this item will pop-up. Otherwise, no external information will pop-up and the video/image will play as regular forms;
the information embedded videos/images can be played either from the client side through the user operation interface module, or directly on the server through the user operation interface module and the client-server operation interface module;
a lock/unlock bottom can be used to disable/enable the label pop-up functionality in videos/images.

5. The interactive video/image-relevant information embedding technology of claim 1, wherein the external-information retrieval engine can be linked the text-based or image-based search engine, label dataset, or additional database, such that the analysis result of the specified item from the video/image content analysis module can be used as the query input to these search or retrieval engines for retrieving external information related to the specified item.

6. The interactive video/image-relevant information embedding technology of claim 2, wherein the external-information retrieval engine can be linked the text-based or image-based search engine, label dataset, or additional database, such that the analysis result of the specified item from the video/image content analysis module can be used as the query input to these search or retrieval engines for retrieving external information related to the specified item.

7. The interactive video/image-relevant information embedding technology of claim 1, wherein a video/image content analysis module is used on both the server side and the client side for segmenting, tracking, recognizing the user-specified items in the videos/images in an automatic or manual way.

8. The interactive video/image-relevant information embedding technology of claim 2, wherein a video/image content analysis module is used on both the server side and the client side for segmenting, tracking, recognizing the user-specified items in the videos/images in an automatic or manual way.

9. The interactive video/image-relevant information embedding technology of claim 1, wherein a label-embedding engine or a video/image-external information relation analysis module is used on the client side or on the server side. This engine or module inputs the analysis information of the video/image content analysis module as well as the external information from the label information database or external-information retrieval engine, and outputs the created labels.

10. The interactive video/image-relevant information embedding technology of claim 2, wherein a label-embedding engine or a video/image-external information relation analysis module is used on the client side or on the server side. This engine or module inputs the analysis information of the video/image content analysis module as well as the external information from the label information database or external-information retrieval engine, and outputs the created labels.

11. The interactive video/image-relevant information embedding technology of claim 1, wherein a video/image database and the label database are used on the client side and on the server side for saving the video/image data and label files, respectively.

12. The interactive video/image-relevant information embedding technology of claim 2, wherein a video/image database and the label database are used on the client side and on the server side for saving the video/image data and label files, respectively.

13. The interactive video/image-relevant information embedding technology of claim 1, wherein two kinds of interfaces are used, including:
a user operation interface module used on the client side for interacting with the user or label creator for uploading videos/images, adding label information, creating information-embedded videos/images, playing information-embedded videos/images, acquiring interested items or item information, and other operations;
a client-server operation interface module used on both the server side and the client side for interaction between the client and the server sides for uploading/downloading files, user information verification, user log-in operation, transferring operation information, and other operations.

14. The interactive video/image-relevant information embedding technology of claim 2, wherein two kinds of interfaces are used, including:
a user operation interface module used on the client side for interacting with the user or label creator for uploading videos/images, adding label information, creating information-embedded videos/images, playing information-embedded videos/images, acquiring interested items or item information, and other operations;
a client-server operation interface module used on both the server side and the client side for interaction between the client and the server sides for uploading/downloading files, user information verification, user log-in operation, transferring operation information, and other operations.

15. The interactive video/image-relevant information embedding technology of claim 3, wherein two kinds of interfaces are used, including:
a user operation interface module used on the client side for interacting with the user or label creator for uploading videos/images, adding label information, creating information-embedded videos/images, playing information-embedded videos/images, acquiring interested items or item information, and other operations;
a client-server operation interface module used on both the server side and the client side for interaction between the client and the server sides for uploading/downloading files, user information verification, user log-in operation, transferring operation information, and other operations.

16. The interactive video/image-relevant information embedding technology of claim 1, wherein for the client-server structure:
one or several servers can interact with multiple clients for multi-user/label creator interactive information embedding and video/image display;
the client device includes TV, PC, Smart phone, Smart Pad, projector, or other video/image display equipments;
the server device includes workstation, sever, and cloud platform.

17. The interactive video/image-relevant information embedding technology of claim 2, wherein for the client-server structure:
one or several servers can interact with multiple clients for multi-user/label creator interactive information embedding and video/image display;
the client device includes TV, PC, Smart phone, Smart Pad, projector, or other video/image display equipments;
the server device includes workstation, sever, and cloud platform.

18. The interactive video/image-relevant information embedding technology of claim 1, wherein for the interested items in videos/images:
the items can be selected by the users for label embedding or popping-up by many ways, including: moving their cursor on the item, or circling the item, or clicking the item;
the items can be any item in the videos/images, including but not limited to person, dressings, animals, make-ups, person' s face with make-ups, plants, objects, landscapes, locations, restaurants, backgrounds, and etc;
some additional marks can be marked on the items in videos/images indicating that the items are clickable for more external information (i.e., can pop-up labels). The marks include but not limited to: underlined words, bullet point, a small colored block, a watermark, and etc;
the closing of the popped-up label can take various ways, including but not limited to: move away the curser from the item to close the label, click the close bottom in the pop-up label to close, click elsewhere in the video/image to close label, and etc.

19. The interactive video/image-relevant information embedding technology of claim 2, wherein for the interested items in videos/images:
the items can be selected by the users for label embedding or popping-up by many ways, including: moving their cursor on the item, or circling the item, or clicking the item;
the items can be any item in the videos/images, including but not limited to person, dressings, animals, make-ups, person' s face with make-ups, plants, objects, landscapes, locations, restaurants, backgrounds, and etc;
some additional marks can be marked on the items in videos/images indicating that the items are clickable for more external information (i.e., can pop-up labels). The marks include but not limited to: underlined words, bullet point, a small colored block, a watermark, and etc;
the closing of the popped-up label can take various ways, including but not limited to: move away the curser from the item to close the label, click the close bottom in the pop-up label to close, click elsewhere in the video/image to close label, and etc.

20. The interactive video/image-relevant information embedding technology of claim 3, wherein for the interested items in videos/images:
the items can be selected by the users for label embedding or popping-up by many ways, including: moving their cursor on the item, or circling the item, or clicking the item;
the items can be any item in the videos/images, including but not limited to person, dressings, animals, make-ups, person' s face with make-ups, plants, objects, landscapes, locations, restaurants, backgrounds, and etc;
some additional marks can be marked on the items in videos/images indicating that the items are clickable for more external information (i.e., can pop-up labels). The marks include but not limited to: underlined words, bullet point, a small colored block, a watermark, and etc;
the closing of the popped-up label can take various ways, including but not limited to: move away the curser from the item to close the label, click the close bottom in the pop-up label to close, click elsewhere in the video/image to close label, and etc.
